(19) United States
(12) Patent Application Publication
(10) Pub. No.: US 2015/0033755 A1
(43) Pub. Date: Feb. 5, 2015

(54) TREATMENT OF A FEEDSTOCK MATERIAL

(71) Applicant: ADVANCED PLASMA POWER LIMITED, Swindon (GB)

(72) Inventor: Richard Taylor, St. Dennis (GB)

(73) Assignee: ADVANCED PLASMA POWER LIMITED, Swindon (GB)

(21) Appl. No.: 14/379,839

(22) PCT Filed: Feb. 21, 2013
(86) PCT No.: PCT/GB2013/050419

§ 371 Date: Aug. 20, 2014

(30) Foreign Application Priority Data
Feb. 21, 2012 (GB) 1202957.5

(51) Int. Cl. C10J 3/84; F02B 43/10; F02C 3/22; F23G 5/027; F23G 5/30

(52) U.S. Cl. CPC C10J 3/84; F23G 5/027; F23G 5/30; F02C 3/22; F02B 43/10; C10J 2300/1618; C10J 2300/165; C10J 2300/1853; C10J 2300/1637
USPC 60/780; 48/197 FM; 48/204; 123/3

(57) ABSTRACT

The present invention relates to a method for the treatment of a feedstock material, the method comprising: (i) thermally treating a feedstock material to produce an syngas; and (ii) plasma-treating the syngas in a plasma treatment unit in the presence of additional carbon dioxide to produce a refined syngas, wherein the additional carbon dioxide is added to the feedstock material during the thermal treatment and/or to the syngas before plasma treatment and/or introduced in the plasma treatment unit.

### REFERENCE TO RELATED APPLICATIONS

This application is a U.S. national stage application of International Patent Application No. PCT/GB2013/050419, filed Feb. 21, 2013, and claims the benefit of priority of Great Britain Application No. 1202957.5, filed Feb. 21, 2012, the entire disclosures of which are incorporated herein by reference.

### BACKGROUND

The present invention relates to a method for the treatment of a feedstock material. The method produces a useful refined syngas from a carbon-containing material or fuel, preferably from waste. In particular, the present invention relies upon the plasma treatment in the presence of carbon dioxide of a refined syngas produced from a feedstock.

EP1896774, incorporated herein by reference, discloses the treatment of a feedstock such as municipal waste in a two step process. Firstly, the feedstock is gasified in a gasification unit. Gasification, while being moderately successful in treating the majority of suitable feedstocks, nevertheless produces a gas that contains uncombusted particulates, low volatility tarry species, airborne compounds and a solid non-airborne char.

The gas that results from this gasification of feedstock (termed an ‘refined syngas’) can be used in a gas turbine or gas engine, but the airborne particulates and tarry hydrocarbon molecules have a tendency to clog the turbine or engine. EP1896774 therefore discloses a plasma treatment of the syngas and the solid non-airborne char in a plasma treatment unit. This gasifies any remaining organic species from the char, which it then vitrifies, and cracks any airborne organic species into predominantly carbon monoxide and hydrogen for use in a gas turbine or gas engine.

When treating a feedstock material to produce a refined syngas fuel for gas turbines or gas engines, it is desirable to obtain a fuel with the highest practical calorific value and the lowest levels of impurities. The process disclosed in EP1896774 may be used to produce a high calorific refined syngas from a homogenised organic material of constant calorific value (CV). Nevertheless, there is a desire for a more efficient process and the production of a higher calorific product per ton of feedstock and/or per unit time of processing.

### SUMMARY OF THE INVENTION

Accordingly, there is a desire for an improved process that will overcome, or at least mitigate, some or all of the problems associated with the methods of the prior art or at least a useful or optimised alternative.

According to a first aspect, the present invention provides a method for the treatment of a feedstock material, the method comprising:

(i) thermally treating a feedstock material to produce an syngas; and

(ii) plasma-treating the syngas in a plasma treatment unit in the presence of additional carbon dioxide to produce a refined syngas,

wherein the additional carbon dioxide is added to the feedstock material during the thermal treatment and/or to the syngas before plasma treatment and/or introduced in the plasma treatment unit.

The present disclosure will now be further described. In the following passages different aspects of the disclosure are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

According to a second aspect, there is provided a method for the treatment of a syngas, the method comprising:

plasma-treating the syngas in a plasma treatment unit in the presence of additional carbon dioxide to produce a refined syngas.

### BRIEF DESCRIPTION OF THE FIGURE

FIG. 1 shows a flowchart of the method of the invention.

### DETAILED DESCRIPTION OF THE PREFERRED EMBODIMENTS

The methods of the present invention are directed to the production of useful products; in particular, a refined syngas, carbon monoxide, carbon dioxide gas, and/or hydrogen gas, from a feedstock material. The methods of the present invention rely upon the plasma treatment of a syngas, which leads to the production of a refined syngas which can be subjected to a water-gas shift reaction to produce carbon dioxide; separated to obtain hydrogen and/or carbon dioxide; combusted; or used as a fuel source.

The feedstock material is a carbon-containing feedstock material. The feedstock material is preferably a waste material, although any carbonaceous fuel can be treated. Preferred feedstock materials are discussed below. It is especially preferred that the feedstock material is a refuse derived fuel (RDF). Preferably the feedstock material is dried before use.

Gasification of a feedstock material is well known. The gasification preferably takes place in the presence of oxygen and water. Preferably, gasification is carried out at a temperature of from 650 to 950° C. The oxidant content is closely monitored to ensure that gasification takes place and a rich hydrogen and carbon monoxide refined syngas is produced. The gasification unit is preferably a fluidised bed gasifier and the inventors have found that CO₂ can be advantageously used to aid in fluidising the bed. Preferably the feedstock material is gasified in the gasification unit until substantially all of the feedstock material is converted into the syngas and the solid non-airborne char; this gives the highest possible energy yield from the feedstock material.

Plasma treatment of a syngas is well known. The plasma treatment serves to crack more complex hydrocarbons present in the syngas and to increase the carbon monoxide and hydrogen content of the syngas. Plasma treatment units may rely upon a plasma stabilising gas. The present inventors have discovered that when this is CO₂, there is an increase in the calorific content of the refined syngas produced.

Since the plasma treatment and gasification treatments are both sensitive to the presence of air, it is important that the reactions are carried out under sealed conditions. Preferably, therefore, the feedstock material is fed into the gasification unit through an air lock. Moreover, the reactions are carried out under a negative pressure to prevent loss of syngas and, especially where the treated materials can be hazardous, to prevent their loss. The use of a negative pressure in the reaction vessels risks the entrainment of gases into the reaction vessels (treatment units).

The present inventors have discovered that it is important to use an inert gas to maintain the seals on the gasification and plasma treatment units. Therefore, when gas is drawn into the system, the gas is an inert gas and not additional oxygen: additional oxygen or air can disrupt the finely balanced reactions carried out in the treatment units. Moreover, all of the benefits discussed herein that result from the use of CO₂ may be realised.

Moreover, the inventors have surprisingly discovered that carbon dioxide is the ideal inert gas to use. Whereas nitrogen is a cheap and most readily available substantially inert gas, the use of carbon dioxide as an inert gas to maintain the seals has been found to have a large number of unexpected advantages.

The use of carbon dioxide as an inert sealing gas avoids the introduction of additional oxygen into the treatment units. Furthermore, it avoids the introduction of any undesirable inert diluents, such as nitrogen, into the gas stream. The presence of any inert diluents will lower the calorific density of the gas and may lead to costly separation being required.

The use of carbon dioxide in the gasification step is advantageous because it can be used as a gas for fluidising fluidised beds. It can also act as an oxidant during gasification, and the same advantages are observed as described in relation to plasma treatment, albeit to a lesser extent at the lower temperatures. In other respects, the carbon dioxide is simply an inert gas during gasification.

The use of carbon dioxide in the plasma treatment step, as indicated above, leads to a surprising increase in the calorific content of the final refined syngas. Moreover, it avoids the introduction of undesirable diluent gas. Furthermore, at the high temperatures of the plasma treatment it acts as an oxidant and can reduce the amount of oxygen and/or steam that are required. The use of reduced oxygen is desirable in view of the costs associated with oxygen purification. In addition to reacting with hydrocarbons, oxygen added to the plasma treatment stage will also react to a certain extent with the hydrogen and carbon monoxide to produce carbon dioxide and water, further reducing the calorific content of the refined syngas: the carbon dioxide does not react to the same extent as an oxidant and, hence, it is highly desirable to at least partially replace the oxygen in the plasma treatment step with carbon dioxide.

The present inventors have also discovered that it is possible to use the amounts of carbon dioxide addition to “engineer” the quality of the refined syngas for specific purposes. That is, for example, the addition of carbon dioxide during gasification and/or plasma treatment can adjust the H₂/CO ratio such that the refined syngas generated becomes more suitable as a raw material feedstock into chemical processes.

Surprisingly, the inventors have also found that the use of carbon dioxide in the gasifier increases the reaction kinetics of the gasification. This allows for a higher efficiency since the same reaction conditions (temperatures, pressures etc.) can be used to process a faster through-put of feedstock material.

The use of carbon dioxide has been found to be especially advantageous due to the possibility of recycling carbon dioxide through the process. The carbon dioxide can be separated from the refined syngas, or even more favourably, separated from the combustion product of the refined syngas (i.e. after use of the refined syngas to produce energy in a gas turbine) and fed back into the system as required. As a further alternative, a portion of the refined syngas may be passed back as the gasifying agent. This carbon-dioxide-rich gas would avoid the need for separation processes. In such a case the water vapour present in the syngas would partially offset the need to introduce steam. In this case it would be highly desirable to use carbon dioxide as an inerting gas at process openings (e.g. feed ports, etc.) Hence, in each case there is a readily available source of inerting gas, plasma stabilising gas, and fluidising gas on-site; this avoids the need to buy, extract or store the gas, as would be required for inert gases such as nitrogen.

The present inventors have now discovered that the use of CO₂ in the treatment units leads to a higher calorific refined syngas product. Surprisingly, the use of CO₂ can result in up to a 30% increase in the calorific value of the refined syngas.

Preferably the additional carbon dioxide is added to the feedstock material during the thermal treatment and introduced in the plasma treatment unit. That is, advantageously, carbon dioxide is added into both treatment steps of the present invention.

Preferably the thermal treatment is carried out in a separate treatment unit from the plasma treatment unit. Preferably, the thermal treatment is gasification carried out in a gasification unit. The gasification treatment is highly efficient and useful for treating a broad range of feedstocks. Preferably, the gasification unit is a fluidised bed gasifier. Such units allow for fast processing times, continuous thermal treatment and predictable conditions and residency times.

Where the gasification unit is a fluidised bed, preferably the fluidised bed is fluidised by introducing a flow of carbon dioxide and/or oxygen and/or steam into the fluidised bed gasifier. This helps to ensure good contact between the feedstock and the oxidant gases. Preferably the gases are cycled through the bed to ensure thorough treatment of the material and gases.

The gasification process will generally produce both an syngas and a solid non-airborne char. preferably both the syngas and a solid non-airborne char are plasma treated. The plasma treatment of the syngas allows for the cracking and reforming of hydrocarbon species in the gas. The plasma treatment of the char material allows for the production of a low volume vitrified material and allows for high efficiency recovery of carbon species from the char. Preferably, to maximise efficiency, the syngas and a solid non-airborne char are plasma treated in the same plasma treatment unit.

Preferably, the feedstock material is fed into the gasification unit and/or the plasma treatment unit through an air lock. Preferably the entire system is kept air-tight to prevent the ingress of any unwanted diluent gases and to prevent the escape of any syngas or harmful gaseous species. Preferably the gasification unit and plasma treatment unit are maintained under a negative pressure.

Preferably the gasification is carried out in the presence of additional carbon dioxide, oxygen and steam. In particular, preferably the gasification is carried out in an atmosphere consisting essentially of syngas, oxygen, steam and carbon dioxide, together with unavoidable impurities. The presence of further gases would act as a diluent for the final refined syngas, reducing its calorific value.

Preferably, the gasification is carried out at a temperature of from 650 to 950° C. This temperature range permits thorough gasification of the feedstock material without requiring the use of excessive heating.

Preferably the plasma treatment is carried out in the presence of additional carbon dioxide, oxygen and, optionally, steam. In particular, preferably the plasma treatment is carried out in an atmosphere consisting essentially of syngas, refined syngas, oxygen, carbon dioxide and, optionally, steam, together with unavoidable impurities. The presence of further gases would act as a diluent for the final refined syngas, reducing its calorific value.

Preferably, during an initial warm-up stage, the ratio of oxygen and steam to carbon dioxide added in the plasma treatment unit is greater than the ratio of oxygen and steam to carbon dioxide during steady continuous processing. This allows for the apparatus to be brought quickly up to temperature with the more energetic oxidation reactions. The subsequent use of more carbon dioxide reduces the cost of running the processing unit due to the more ready availability of the gas. In this way, the carbon dioxide addition can be used to control the gas conditions and reaction rate by replacing a portion of the oxygen/steam. Preferably, the carbon dioxide is only added directly to the system once the temperature has stabilised and gasification is occurring. Prior to this carbon dioxide may be used as a inerting gas to maintain the seals.

Preferably the plasma treatment is carried out at a temperature of from 1000 to 1600° C. This temperature range permits thorough plasma treatment of the syngas and vitrification of the solid char without requiring the use of excessive energy use.

The syngas from the gasifier will generally comprise hydrogen, carbon monoxide, carbon dioxide, water vapour, volatile hydrocarbons and tars. The refined syngas will generally comprise hydrogen, carbon dioxide and carbon monoxide. Preferably the syngas and/or the refined syngas comprise less than 5 v % nitrogen and less than 1 v % noble gases. More preferably, the syngas and/or the refined syngas comprise less than 1 v % nitrogen and noble gases.

Preferably the gasification and the plasma treatment are carried out in an atmosphere consisting essentially of oxygen, steam and carbon dioxide. By consisting essentially, it is meant that the only gases intentionally added to the gasification/plasma treatment unit are oxygen, steam and carbon dioxide, together with unavoidable impurities. Unavoidable impurities preferably do not materially effect the reaction. For example, preferably there is less than 5% vol of impurities, more preferably less than 1% vol and most preferably less than 0.1% vol (of the total reaction unit volume). Ideally, there are no impurities. Another way to describe the atmosphere would be substantially air and/or nitrogen and/or argon free; preferably less than 5% vol total of these gases, more preferably less than 1% vol and most preferably less than 0.1% vol. For the avoidance of doubt, there may also be volatile species released by the feedstock being processed and there will also be the syngas product of the thermal treatments. The carbon dioxide may be freshly introduced in the plasma treatment stage, or may be present only from the syngas leaving the gasifier.

Preferably, before thermal treatment, the feedstock material is flushed with carbon dioxide gas to purge air from the feedstock material. This reduces the presence of any diluent gaseous species in the treatment chamber. It also allows for easier determination of the required oxidant addition required during processing.

Preferably, at least one of: (i) the refined syngas; and (ii) a solid and/or molten material produced in the plasma treatment unit is collected. The refined syngas can be used as a fuel. For example, in a step (iv) the gas produced in the plasma treatment unit may be combusted. Preferably, the gas is combusted in a gas turbine or a gas engine. The solid material and/or molten material may be cooled and used as a building material or aggregate.

It is also possible to treat at least a portion of the refined syngas with steam in a water-gas shift reactor to convert at least some of the carbon monoxide present in the refined syngas into carbon dioxide. This carbon dioxide can be used for any conventional use and is highly pure. Preferably the method comprises recovering carbon dioxide from (a) the refined syngas; and/or (b) gas produced in step (iv). At least a portion of the recovered carbon dioxide can then be used to provide the additional carbon dioxide added to the syngas during the thermal treatment and/or introduced in the plasma treatment unit. This is highly efficient and avoids the requirement to separately store or produce carbon dioxide gas on-site for use in the process.

It is also possible to separate hydrogen from (a) the gas produced in the plasma treatment unit. This hydrogen may be used as a combustible fuel or in an electrical fuel cell to produce electricity. Preferably the hydrogen is separated from the gas following a water-gas shift reaction step as discussed herein; the WGS reaction increases the hydrogen content of the gas.

Before using the refined syngas, it is desirable to remove water from the refined syngas by passing the refined syngas through a condenser unit. This can be important for subsequent gases separation systems.

As previously indicated, in view of the many advantages, preferably the gasification unit is a fluidised bed gasifier, and the bed of the fluidised bed gasifier is fluidised by gaseous carbon dioxide and/or steam and/or oxygen. Most preferably the bed will be fluidised by a flow of carbon dioxide together with sufficient steam and/or oxygen to achieve the desired gasification of the feedstock material.

Preferably, the feedstock material is flushed or purged of air before being introduced into the treatment unit by purging the waste with carbon dioxide. This prevents the ingress of impurities and provides a source of carbon dioxide for the treatment. The use of carbon dioxide is especially advantageous over nitrogen, because the more dense gas can be introduced to sit in a feedstock hopper and thus displace the nitrogen and oxygen. The presence of Nitrogen is not preferred because undesirable NOx impurities may be formed. The Nitrogen may also act as a diluent and reduce the calorific value of the gas produced.

As noted above, preferably the method further comprises collecting at least one of: (i) the gas produced in the plasma treatment unit; and (ii) the solid and/or molten material produced in the plasma treatment unit. The gas from the plasma treatment unit is a refined syngas rich in hydrogen and carbon monoxide. There may also be carbon dioxide present in the gas that can be recycled in the process.

Carbon monoxide and hydrogen may be used as a fuel source for the production of energy. This may be released by combustion or in chemical reactions. The production of energy is preferably achieved with a gas turbine or a gas engine.

Alternatively, the carbon monoxide and hydrogen may be contacted with water to perform a so-called water-gas shift reaction and to increase the carbon dioxide content of the gas. This highly pure source of carbon dioxide can, for example, be used for sequestering or enhanced oil recovery methods, or recycled through the process. The hydrogen can be separated and used as a fuel or in an electrochemical cell.

Methods for separating gases are well known in the art. A suitable method for the extraction of carbon dioxide from a gas is using an alkanolamines chemical solvent. The reactivity and availability at low cost, especially of monoethanolamine (MEA), and diethanolamone (DEA), make these solvents ideal. Chemical absorption processes are based on exothermic reaction between the solvent and the CO₂ present in the gas stream. Most chemical reactions are reversible, in this case solvent removes CO₂ in the contactor (absorber), preferably at high pressure (5-200 atm) and preferably at low temperature (35-50° C.). The reaction is then preferably reversed by endothermic stripping process at high temperature (90-120° C.) and low pressure (1.4-1.7 atm). The CO₂ recovery rates from amine-based solvent are preferably at least 95%, more preferably at least 98% and most preferably 99% or higher.

As discussed above, gasification is the partial combustion of a material, where the oxygen in the gasification unit is controlled such that it is present at a sub-stoichiometric amount, relative to the material. Gasification of feedstock containing carbonaceous components results in a combustible fuel gas, or refined syngas, rich in carbon monoxide, hydrogen and some saturated hydrocarbons, principally methane. The gas produced also contains some carbon dioxide and moisture. Non-limiting examples of gasification and gasification units suitable for use in the present invention are disclosed in EP1896774.

The process according to the present invention preferably comprises a gasification step. The gasification step may, for example, be carried out in a vertical fixed bed (shaft) gasifier, a horizontal fixed bed gasifier, a fluidised bed gasifier, a multiple hearth gasifier or a rotary kiln gasifier.

Preferably, the gasification step is carried out in a fluid bed gasification unit. Fluid bed gasification has been found to process the feedstock more efficiently than the other gasification processes available. The fluid bed technique permits very efficient contacting of the oxidant and feed streams leading to rapid gasification rates and close temperature control within the unit.

A typical fluid bed gasification unit may comprise a vertical steel cylinder, usually refractory lined, with a sand bed, a supporting grid plate and air injection nozzles known as tuyeres. When air is forced up through the tuyeres, the bed fluidises and expands up to twice its resting volume. Solid fuels such as coal or refused derived fuel, or in the case of the present invention, the feedstock, can be introduced, possibly by means of injection, into the reactor below or above the level of the fluidised bed. The “boiling” action of the fluidised bed promotes turbulence and transfers heat to the feedstock. In operation, auxiliary fuel (natural gas or fuel oil) is used to bring the bed up to operating temperature 550° C. to 950° C., preferably 650° C. to 850° C. After start-up, auxiliary fuel is usually not needed.

Preferably the gasification unit has an inlet for oxygen, an inlet for carbon dioxide and optionally an inlet for steam and the plasma treatment unit has an inlet for oxygen, an inlet for carbon dioxide and optionally an inlet for steam. “Steam” includes water in the gaseous form, vapour and water suspended in a gas as droplets. Preferably, the steam is water having a temperature of 100° C. or more. Water, which will be converted to steam, may be introduced into the gasification unit and/or plasma treatment unit in the form of liquid water, a spray of water, which may have a temperature of 100° C. or less, or as vapour having a temperature of 100° C. or more; in use, the heat in the interior of the gasification unit and/or plasma treatment unit ensures that any liquid water, which may be in the form of airborne droplets, is vaporised to steam.

Preferably the gasification unit, most preferably the fluid bed gasification unit, will be a vertical, cylindrical vessel, which is preferably lined with an appropriate refractory material, preferably comprising alumina silicate.

In a fluid bed gasification unit, the distance between the effective surface formed by the particles of the fluid bed when fluid (i.e. when gas is being fed through the particles from below) and the top of the unit is called the “free board height”. In the present invention, the free board height, in use, will preferably be 2.5-5.0 times the internal diameter of the unit. This geometric configuration of the vessel is designed to permit adequate residence time of the feedstock within the fluid bed to drive the gasification reactions to completion and also to prevent excessive carry over of particulates into the plasma unit. The gasification unit will preferably employ a heated bed of ceramic particles suspended (fluidized) within a rising column of gas. The particles may be sand-like.

Preferably, the feedstock will be fed continuously to the gasification unit at a controlled rate. If the gasification unit is a fluid bed gasification unit, preferably the feedstock is fed either directly into the bed or above the bed.

Preferably, the feedstock feed will be transferred to the gasifier unit using a screw conveyor system, which enables continuous addition of feedstock.

During the gasification process, the gasification unit should be sealed from the surrounding environment to prevent ingress or egress of gases to/from the gasification unit, with the amount of carbon dioxide and oxygen and/or steam being introduced to the gasification unit as required in a controlled manner.

If the gasification unit is a fluid bed gasification unit, preferably oxidants comprising oxygen and steam are fed below the bed, which may be through a series of upward facing distribution nozzles. The carbon dioxide, which can act as an oxidant, is also fed into the gasification chamber in this way.

The gasification may be carried out in the presence of carbon dioxide, steam and oxygen. As mentioned above, water, which will be converted to steam, may be introduced into the gasification unit in the form of liquid water, a spray of water, which may have a temperature of 100° C. or less, or as vapour having a temperature of 100° C. or more. In use, the heat in the interior of the gasification unit ensures that any liquid water, which may be in the form of airborne droplets, is vaporised to steam. Preferably the carbon dioxide, steam and oxygen will be closely metered to the unit and the rate of feed adjusted to ensure that the gasifier operates within an acceptable regime. The amount of carbon dioxide, oxygen and steam introduced to the gasification unit relative to the amount of feedstock will depend on a number of factors including the composition of the feed, its moisture content and calorific value. Preferably, the amount of oxygen introduced to the gasification unit during the gasification step is from 300 to 450 kg per 1000 kg of feedstock fed to the gasification unit. Preferably, the amount of steam introduced to the gasification unit is from 0 to 350 kg per 1000 kg of feedstock introduced to the gasification unit, more preferably from 300 to 350 kg per 1000 kg of feedstock if the feedstock contains less than 18% by weight moisture. If the feedstock contains 18% or more by weight moisture, preferably the amount of steam introduced to the gasification unit is from 0 to 150 kg per 1000 kg of feedstock.

The gasification unit will preferably comprise a fossil fuelled underbed preheat system, which will preferably be used to raise the temperature of the bed prior to commencement of feeding to the unit.

Preferably the gasification unit will comprise multiple pressure and temperature sensors to closely monitor the gasification operation.

Preferably the feedstock will be gasified in the gasification unit at a temperature greater than 650° C., more preferably at a temperature greater than 650° C. up to a temperature of 1000° C., most preferably at a temperature of from 800° C. to 950° C.

Fluid bed gasification systems are quite versatile and can be operated on a wide variety of fuels, including municipal waste, sludge, biomass materials, coal and numerous chemical wastes. The gasification step of the process of the present invention may comprise using a suitable bed media such as limestone (CaCO₃), or, preferably, sand or a refractory alumino-siicate. During operation, the original bed material may be consumed, and may be replaced by recycled graded ash (Char) material from the gasification stage.

Preferably, the whole process is an integrated process, in that all the steps are carried out on one site and means are provided to transport the products from each step to the next. The syngas can, for example, be treated by plasma (torches) at the top of the gasifier column, or in a duct external to the gasifier or in an entirely separate vessel. Each step is preferably carried out in a separate unit. In particular, the gasification and the plasma treatment are carried out in separate units, to allow the conditions in each unit to be varied independently. In the event that the treatments are carried out in the same processing unit, it is preferred that the means for gasification is distinct from the means for plasma treatment. Moreover, it is preferred that the gasification and plasma treatment are not carried out in a single plasma treatment step due to the low efficiency of such treatments. Where the syngas is treated, but the solid non-airborne char material also produced is not, it may not be necessary or desirable for separate treatment units to be used.

The syngas is plasma treated in a plasma treatment unit. The solid non-airborne char produced by gasification may also be plasma treated. Preferably this occurs in a single plasma treatment unit, but the use of separate treatment units is also contemplated. This serves to crack any hydrocarbons present in the syngas and increase the amounts of hydrogen and carbon monoxide present in the syngas. The plasma treatment is carried out under controlled conditions to ensure that additional carbon dioxide production is reduced and the hydrogen is not converted to water. Preferably the plasma treatment is carried out in the presence of steam.

The process according to the present invention comprises a plasma treatment step. The plasma treatment is preferably carried out in the presence of carbon dioxide and oxygen and/or steam, which each can act as an oxidant. Preferably, the amount of oxidant is controlled and preferably, the amount of oxygen and/or steam is reduced in favour of the carbon dioxide which acts as a cheaper, easier to source, oxidant and which contributes to the final calorific refined syngas. More preferably, the amount of oxidant is controlled such that that the gaseous hydrocarbons (including low volatility, tar products), the airborne carbon particulates, carbon contained in the char and part of the carbon monoxide is converted to carbon monoxide and carbon dioxide, preferably such that the ratio of the CO/CO₂ after the plasma treatment stage is equal or greater than the gas exiting the gasifier unit. Preferably, the plasma treatment is carried out on the char until substantially all of the carbon content in the char has been converted to gas or airborne species.

As mentioned above, water, which will be converted to steam, may be introduced into plasma treatment unit in the form of liquid water, a spray of water, which may have a temperature of 100° C. or less, or as vapour having a temperature of 100° C. or more. In use, the heat in the interior of the gasification unit and/or plasma treatment unit ensures that any liquid water, which may be in the form of airborne droplets, is vaporised to steam.

Preferably, the ratio of oxygen to steam is from 10:1 to 2:5, by weight.

Preferably, the plasma treatment of the feedstock is carried out at a temperature of from 1000 to 1700° C., preferably from 1100 to 1600° C. and most preferably from 1200 to 1400° C.

Preferably, water, which will be converted into steam, is introduced into the plasma treatment unit in the form of a spray of water having a temperature below 100° C. There are two main advantages of doing so: firstly, the water in the spray has the effect of cooling the refined syngas produced in the plasma unit due to promotion of the endothermic reaction of water with carbon (to produce hydrogen and carbon monoxide). Secondly, the overall chemical enthalpy of the produced refined syngas is increased, allowing a greater export of electrical power if the gas is used to generate electricity. (i.e. giving an improvement in the overall net electrical conversion efficiency). Introduction of water during gasification or plasma treatment advantageously reduces the amount of water required during the WGS reaction.

If the chemical composition and mass throughput of the reactants are generally constant, then the ratio of oxidant to the reactant streams (containing the feedstock) will also preferably be maintained at a constant value. An increase in the feed rate of the reactants will preferably lead to a proportionate increase in the oxidant addition rate, which may be controlled by automatic oxidant addition means. The electrical power supplied to the plasma will also preferably be adjusted to match the change in the feed rate of the feedstock to the plasma unit and will take account of the thermo-chemistry of the system and the thermal losses from the unit.

The gas produced from the plasma treatment may, optionally, be treated in a gas cleaning plant. This is preferable since it reduces the potential pollutants that may be produced from the process output. Such plants are well known in the art and serve to remove harmful or undesirable gases or particulates from a gas. Such treatments generally produce a so-called Air Pollution Control (APC) residue which may be treated as a hazardous waste feedstock in the first plasma treatment unit.

The feedstock is preferably a biomass feedstock. That is, the feedstock comprises a substantial amount of hydrogen, carbon and oxygen. Suitable biomass feedstocks include one or more of wood, waste, fossil fuels, and plant-derived matter. Preferably the feedstock is a waste material, preferably a municipal waste or a refuse derived fuel.

If municipal waste is used then it is preferred that this has been pre-treated to ensure that it has a substantially constant CV. Suitable pre-treatment methods include sorting, picking, homogenising and microbial treatment. It is most preferred that the waste stream is predominantly Refuse Derived Fuel and/or Solid Recovered Fuel. These are commercially available and well known in the art.

The feedstock may have been pre-treated to increase its homogeneity prior to thermal treatment. “Homogenous” indicates that the feedstock should have one or more properties which do not vary to a great extent throughout the bulk of the feedstock or from batch to batch, if the feedstock is fed in batches to the treatment unit; hence the value of the property in question does not vary to a great extent as the feedstock is fed to the treatment unit. Such properties that preferably do not vary to a great extent include the calorific value, the size of constituents, moisture content, ash content, and density of the material. Preferably one or more of these properties varies by 20% or less, preferably 15% or less, more preferably 10% or less. Preferably, the calorific value and the moisture content of the material being fed are relatively consistent during the process.

Various processes may be used to homogenise various properties of the feedstock material, for example: microbial digestion, picking, shredding, drying, screening, mixing and blending. Of these, microbial digestion is preferred and this process is explained in more detail below.

The consistency of the property/properties of interest may be measured by taking samples of the same weight from either (i) a given number of batches of the feedstock fed to the treatment unit over a period of time (if the feedstock is fed batch-wise to the treatment unit) or (ii) at given intervals of time if the feedstock is fed substantially continuously to the treatment unit. Sampling methods known to the skilled person may be used to measure the consistency of the feedstock. Furthermore, the consistency of the processed material may be determined by taking samples from the treatment unit, after the treatment unit and/or before or after plasma treatment.

The feedstock preferably has a moisture content of 30% or less by weight, preferably 20% or less by weight. The moisture content of the feedstock preferably varies by 10% or less, more preferably by 5% or less. The moisture content of the feedstock may be controlled using processes known to those skilled in the art, such as drying, or by using the microbial digestion processes described herein.

The method is preferably carried out as a continuous method. However, it should be appreciated that the feedstock material may be processed in a batchwise manner.

As described above, the feedstock may be subjected to various types of treatment before the gasification. Preferably, the previous steps include any or all of the following:
1. Picking—Initial treatment to remove objects which are not readily combustible, such as stone, concrete, metal, old tyres etc. Objects having a size in excess of 100 mm or more may also be removed. The process can be carried out on a stationary surface, such as a picking floor. Alternatively or additionally, the feedstock may be loaded onto a moving surface such as a conveyor and passed through a picking station in which mechanical or manual picking of the material takes place.
2. Shredding—Shredding is a highly preferred step. It is carried out to reduce the average particle size. It can also be used to increase blending of feedstock from different sources. It also makes the treatment process more effective. It is found that, during the shredding process, microbial activity may commence and rapidly raise the temperature passing very quickly through the mesophilic phase into the thermophilic phase.
3. Screening—The feedstock may be mechanically screened to select particles with size in a given range. The given range may be from 10 mm to 50 mm. Material less than 10 mm in size comprises dust, dirt and stones and is rejected. The feedstock may be treated to at least two screening processes in succession, each removing progressively smaller fractions of particles. Material removed in the screening process as being too large may be shredded to reduce its average size. Material which is classified by the screen as being of acceptable size and, where applicable, shredded material can then be fed to the treatment vessel.

The feedstock may be subjected to a number of steps before the gasification step. These steps may include any of the following:
1. Grading—The material may be screened to remove particles in excess of a given size. For example, particles in excess of 80 mm may be rejected. They may be subsequently shredded to reduce their size, returned to the aerobic digester or simply rejected.
2. Metal Separation—Relatively small metal particles such as iron or aluminium may have passed through the system. They can be removed, for example by a magnetic or electromagnetic remover in a subsequent step. Metal particles removed from the system may then pass to a suitable recycling process.
3. Drying—Suitably, after treatment in the microbial treatment vessel, the feedstock is subjected to an additional drying step. If the moisture level does not exceed 45% by weight, more preferably does not exceed 35% by weight and most preferably does not exceed 25% by weight, after the microbial treatment, the subsequent drying can be carried out relatively simply. For example, in a first drying stage, a forced draught of air may be provided during or after the unloading phase from the treatment vessel. During this stage, the feedstock treated by the microbial digestion stage will still be at high temperature (for example in the range 50-60° C.) and further moisture can be removed simply by forcing air over it. A further drying step may comprise laying the material out on a drying floor. In this step, feedstock is laid out at a thickness of not more than 20 cm over a relatively large area for a suitable period of time, during which the moisture level drops. The feedstock may be agitated, for example by turning using mechanical or manual apparatus such as a power shovel. The feedstock may be turned at intervals of for example of 2-4 hours preferably around 3 hours. Preferably, during this stage, the moisture level drops to below 25% by weight after which no further biological decomposition occurs. Suitably, the feedstock is left on a drying floor for a period in the range 18-48 hours, preferably 24-36 hours, more preferably around 24 hours. It is also found that further drying may take place during subsequent processing, due to the mechanical input of energy. Waste heat from other process equipment, for example from the gasification and/or the plasma treatment step, may be used to dry the material. Air warmed by the heat generated in the gasification and/or plasma treatment steps may be blown into the microbial feedstock treatment vessel and over or through the feedstock to increase the drying rate of these processes.

Alternatively, the drying apparatus may comprise a rotary flash drier or other drying device.
4. Pelletising—In order to convert the treated feedstock to fuel, the feedstock may be classified according to size and subsequently densified to provide pellets of suitable size for use in the gasification step. During this pelletisation stage, further drying of the feedstock may occur, due to heat generation caused by friction and due to further exposure to air. Preferably, in order for pelletising to proceed well, the moisture level of the treated material is in the range 10-25% by weight.

By blending different sources of feedstock material, fuel produced by the microbial treatment step at different times or with feedstock from different locations can be relatively homogeneous in terms of:
1. Calorific value. The calorific value may be higher if the contents have been significantly dried and/or the proportion of combustibles relative to the ash content of the fuel has increased.
2. Density—suitably in the range 100-350 kg/m³ more preferably around 300 kg/m³.
   3. Moisture level—below 30% by weight and preferably around 20% by weight.

The invention will now be discussed further with reference to the figures, provided purely by way of example, in which:

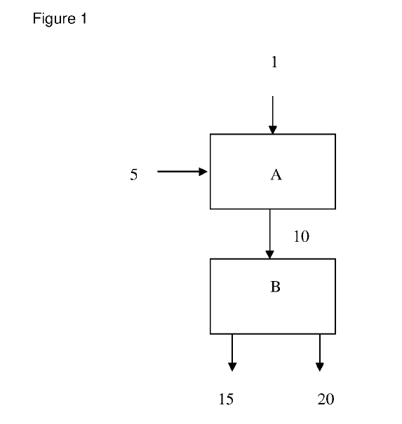

FIG. 1 shows a flow chart of a method of the present invention.

As shown in FIG. 1, a feedstock material 1 is fed into a fluidised bed gasification unit A via a screw-feed hopper. Carbon dioxide gas is used to purge the feedstock feed to minimise the introduction of gaseous impurities.

The fluidised bed gasification unit A is fluidised by the introduction of process gases 5 through tuyeres. The process gases 5 include carbon dioxide, oxygen and steam. These process gases 5 are recycled through the fluidised bed gasification unit A.

The gasification treatment is conducted at 650-950° C. and produces an syngas and a solid non-airborne char 10. The syngas is comprised of carbon monoxide and hydrogen, together with some hydrocarbon species. The syngas also includes carbon dioxide and water vapour introduced in the gasification unit. These are passed to the plasma treatment unit B.

In the plasma treatment unit B, the syngas is subjected to plasma treatment. Additional oxygen and/or steam may be added in the plasma treatment unit B. Additional carbon dioxide can also be added, or the carbon dioxide added in the gasification unit can be sufficient. In the hot 1100-1600° C. conditions the carbon dioxide can act as an oxidant and provides a useful increase in the carbon monoxide content of the syngas 15 produced.

The plasma treatment in the plasma treatment unit B produces a solid vitrified waste 20 and a refined syngas 15. The refined syngas 15 has low impurity levels and a high calorific value due to minimal diluent gas species being present. The refined syngas 15 is suitable for use in a gas engine or as a source of carbon dioxide and/or hydrogen gas.

### Example 1

The invention will now be described further with reference to the following non-limiting examples.

The enhancement is shown below for a number of waste feed types and individual tests.

TABLE 1
Impact of instantaneous change from argon to carbon dioxide on refined
syngas quality

| | Waste | | | Inert gas used | | |
|---|---|---|---|---|---|---|
| | composition used | | | in test plant | | |
| | Solids | Automotive | | Argon | CO₂ | |
| | recovered | shredder | | (MJ syngas energy | | |
| | fuel (SRF) | residue (ASR) | Experimental | per measurement | | % Change in switch |
| Result | (% wt) | (% wt) | run number | period) | | from argon to CO₂ |
| Result as measured from | 50 | 50 | 1 | 2.95 | 3.52 | 16.2% |
| test plant data | | | 2 | 2.51 | 3.52 | 28.7% |
| | 100 | 0 | 3 | 1.31 | 1.65 | 20.6% |
| Result as measured | 50 | 50 | 1 | 3.11 | 3.5 | 11.1% |
| (compensating for inert | | | 2 | 2.67 | 3.49 | 23.5% |
| gas dilution effects | 100 | 0 | 3 | 1.45 | 1.72 | 15.7% |
| Result as measured | 50 | 50 | 1 | 5.36 | 6.13 | 12.6% |
| (compensating for inert | | | 2 | 4.8 | 5.86 | 18.1% |
| gas dilution and gas | 100 | 0 | 3 | 2.88 | 3.51 | 17.9% |

The impact of dilution caused by the presence of inerting gas is shown to be around 5-10% (the difference between results measured from the test plant and results compensated for inert gas dilution effects) in terms of the depression of energy output rate. While the presence of excess carbon dioxide appears to boost refined syngas calorific value by around 12-23%, indicating that the enhancement of calorific value is not only by an avoidance of the presence of inert gas, but also due to a change/reaction within the refined syngas itself.

This enhancement in refined syngas calorific value by reaction seems to be primarily caused by the reaction of carbon dioxide with hydrocarbon species present in the refined syngas resulting in increases in the presence of hydrogen and carbon monoxide. The formula below is an outline generic reaction scheme:

aCO₂+CₐH_{b}→(2a)CO+(b/2)H₂

Results obtained from online measurements across two different batches of waste and with different gas additions (see Table 2), indicate the relative levels of key hydrocarbon species. It is evident from these results, that the use of CO₂ in place of argon has a considerable reactivity towards the relatively short-chain paraffin compounds (e.g. methane, acetylene). Levels of these hydrocarbons dropped significantly on switching from argon addition to carbon dioxide—with reductions of, typically, more than 98%. Such reductions are achieved despite no change in the physical operating conditions of the system, indicating an increase in the kinetics of the gasification reactions.

TABLE 2
Effect on gas constituents of switching from argon to carbon dioxide

| | | SRF/ASR blend (50% SRF and 50% ASR) | | | | | | |
|---|---|---|---|---|---|---|---|---|
| | | Hydrocarbon concentration (ppmv) | | | | | | Average |
| | | Experimental Run Number 1 | | | Experimental Run Number 2 | | | % reduction |
| Species | | Argon | CO2 | % Reduction | Argon | CO2 | % Reduction | across tests |
| Methane | CH4 | 23884.78 | 305.81 | 98.7% | 8966.95 | 189.67 | 97.9% | 98.3% |
| Ethylene | C2H4 | 954.99 | 7.57 | 99.2% | 189.67 | 0.14 | 99.9% | 99.6% |
| Propane | C3H8 | 24.47 | 0.00 | 100.0% | 16.46 | 0.03 | 99.8% | 99.9% |
| Benzene | C6H6 | 1856.27 | 614.62 | 66.9% | 294.07 | 284.68 | 3.2% | 35.0% |
| Acetylene | C2H2 | 1695.78 | 0.00 | 100.0% | 377.3 | 0 | 100.0% | 100.0% |
| Phenol | C6H5OH | 45.07 | 10.30 | 77.1% | 27.27 | 9.33 | 65.8% | 71.5% |
| Naphthalene | C10H8 | 255.01 | 0.30 | 99.9% | 6.94 | 0.41 | 94.1% | 97.0% |

| | SRF | | | |
|---|---|---|---|---|
| | Hydrocarbon concentration (ppmv) | | | Average |
| | Experimental Run Number 3 | | | % reduction |
| Species | Argon | CO2 | % Reduction | across tests |

| | | | | | |
|---|---|---|---|---|---|
| Methane | CH4 | 13303.18 | 224.98 | 98.3% | 98.3% |
| Ethylene | C2H4 | 251.35 | 2.66 | 98.9% | 98.9% |
| Propane | C3H8 | 35.38 | 0.00 | 100.0% | 100.0% |
| Acetylene | C2H2 | 493.46 | 0.00 | 100.0% | 100.0% |
| Phenol | C6H5OH | 32.22 | 13.36 | 58.5% | 58.5% |

As demonstrated in the examples, it is especially preferred if carbon dioxide gas is used consistently throughout the process as the only inert gas. This prevents dilution and increases the value of the final gas. Accordingly, carbon dioxide is preferably used to maintain seals in the air-tight system and to flush other gases from the feedstock material before processing.

It is also preferred that the bed is a fluidised bed gasifier and if carbon dioxide is introduced to fluidise the bed, together with the oxidants mentioned above. In this way there is thorough mixing and yet there is no contamination with unwanted gases.

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents.

1. A method for the treatment of a feedstock material, the method comprising:
(i) thermally treating a feedstock material to produce an syngas; and
(ii) plasma-treating the syngas in a plasma treatment unit in the presence of additional carbon dioxide to produce a refined syngas,
wherein the additional carbon dioxide is added to the feedstock material during the thermal treatment and/or to the syngas before plasma treatment and/or introduced in the plasma treatment unit.

2. The method according to claim 1, wherein the additional carbon dioxide is added to the feedstock material during the thermal treatment and introduced in the plasma treatment unit.

3. The method according to claim 1, wherein the thermal treatment is gasification carried out in a gasification unit, preferably in a fluidised bed gasifier.

4. (canceled)

5. The method according to claim 1 wherein the thermal treatment is gasification in a fluidised bed gasifier and wherein the fluidised bed is fluidised by introducing a flow of carbon dioxide and/or oxygen and/or steam into the fluidised bed gasifier.

6. The method according to claim 3, wherein the gasification produces an syngas and a solid non-airborne char, and wherein the syngas and a solid non-airborne char are plasma treated, preferably in the same plasma treatment unit.

7. (canceled)

8. The method according to claim 3, wherein the feedstock material is fed into the gasification unit and/or the plasma treatment unit through an air lock, and wherein the treatment is carried out under air-tight conditions.

9. The method according to claim 3, wherein the gasification is carried out in the presence of additional carbon dioxide, oxygen and steam, and/or wherein the plasma treatment is carried out in the presence of additional carbon dioxide, oxygen and, optionally, steam.

10. The method according to claim 3, wherein the gasification is carried out in an atmosphere consisting essentially of syngas, oxygen, steam and carbon dioxide, together with unavoidable impurities, and/or wherein the plasma treatment is carried out in an atmosphere consisting essentially of syngas, refined syngas, oxygen, carbon dioxide and, optionally, steam, together with unavoidable impurities.

11. The method according to claim 3, wherein the gasification is carried out at a temperature of from 650 to 950° C. and/or wherein the plasma treatment is carried out at a temperature of from 1000 to 1600° C.

12. (canceled)

13. (canceled)

14. The method according to claim 1 wherein the plasma treatment is carried out in the presence of oxygen, and optionally steam, in addition to said additional carbon dioxide and wherein, during an initial warm-up stage of the plasma treating, the ratio of oxygen and steam to carbon dioxide added in the plasma treatment unit is greater than the ratio of oxygen and steam to carbon dioxide during steady continuous processing of the plasma-treating operation

15. (canceled)

16. The method according to claim 1, wherein the syngas comprises hydrogen, carbon monoxide, carbon dioxide, water vapour, volatile hydrocarbons and tars.

17. The method according to claim 1, wherein the refined syngas comprises hydrogen and carbon monoxide.

18. The method according to claim 3, wherein the gasification unit and plasma treatment unit are maintained under a negative pressure.

19. The method according to claim 1, wherein the syngas and/or the refined syngas comprise less than 5 v % nitrogen and less than 1 v % noble gases, preferably less than 1 v % nitrogen and noble gases.

20. (canceled)

21. The method according to claim 1, wherein before thermal treatment, the feedstock material is flushed with carbon dioxide gas to purge air from the feedstock material.

22. The method according to claim 1, the method further comprising collecting at least one of:
(i) the refined syngas; and
(ii) a solid and/or molten material produced in the plasma treatment unit.

23. The method according to claim 1, the method further comprising a step of combusting the gas produced in the plasma treatment unit, preferably in a gas turbine or a gas engine.

24. (canceled)

25. The method according to claim 1, the method further comprising treating at least a portion of the refined syngas with steam in a water-gas shift reactor to convert at least some of the carbon monoxide present in the refined syngas into carbon dioxide.

26. The method according to claim 1, the method further comprising:
(A) recovering carbon dioxide from (a) the refined syngas; and/or (b) a gas produced by combusting the refined syngas; and/or
(B) separating hydrogen from (a) the gas produced in the plasma treatment unit.

27. The method according to claim 26, wherein at least a portion of the recovered carbon dioxide is used to provide the additional carbon dioxide added to the syngas during the thermal treatment and/or introduced in the plasma treatment unit.

28. (canceled)

29. The method according to claim 1, wherein water is removed from the refined syngas by passing the refined syngas through a condenser unit.

30. (canceled)

31. The method according to claim 1, wherein the feedstock material is a waste material, preferably refuse derived fuel.

32. (canceled)

33. The method according to claim 1, wherein the thermal treatment is carried out in a separate treatment unit from the plasma treatment unit.

34. (canceled)

35. (canceled)
